(19) United States
(12) Patent Application Publication
(10) Pub. No.: US 2014/0195365 A1
(43) Pub. Date: Jul. 10, 2014

(54) Bidding on Product and Service Rentals

(71) Applicant: BLING YOURSELF INC., Dallas, TX (US)

(72) Inventor: Carsten Krause, Plano, TX (US)

(73) Assignee: BLING YOURSELF INC., Dallas, TX (US)

(21) Appl. No.: 13/734,757

(22) Filed: Jan. 4, 2013

(51) Int. Cl. G06Q 30/08

(52) U.S. Cl. CPC G06Q 30/08
USPC 705/26.3

(57) ABSTRACT

In some implementations, a method for auctioning includes presenting selection between a deal for a rental period for a product that enables a user to purchase a rental period for a specified amount and an auction a rental period for a product over an auction period. The product is possessed by a partner and a bid server manages the deal and the auction. If the deal is selected, a request is transmitted to the partner to send the user the product. If the auction is selected, whether the user submitted a winning bidder is determined based on bids received during the auction period. A request is transmitted to the partner to ship the product to the user if the user selected the deal or is the winning bidder.

### TECHNICAL FIELD

This invention relates to renting products and, more particularly, to bidding on product rentals, digital product rentals and service product rentals.

### BACKGROUND

Auctions conducted across the Internet have become a very popular method of selling products such as goods and services. In a typical ascending price auction, once a seller has submitted a request to sell a product rental, the product becomes available for bidding over a predetermined time (e.g., two hours, three days). Potential buyers are able to view a description and associated images and submit one or more bids for the product. The potential buyer with the highest bid at the end of the auction wins the auction and is awarded to rent the item for the amount bid.

### SUMMARY

In some implementations, a method for auctioning includes presenting selection between a deal for a rental period for a product that enables a user to purchase a rental period for a specified amount and an auction a rental period for a product over an auction period. This Intellectual Property case does not explicitly specify the type of auction (e.g. English Auction, Dutch Auction, Penny Auction etc.) in the remainder of the document, but implicitly applies this intellectual property patent to all types of auctions for product, digital product and service product rentals The product is possessed by a partner and a bid server manages the deal and the auction. If the deal is selected, a request is transmitted to the partner to send the user the product. If the auction is selected, whether the user submitted a winning bidder is determined based on bids received during the auction period. A request is transmitted to the partner to ship the product to the user if the user selected the deal or is the winning bidder.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an auction system for auctioning products for a specified time period;

FIG. 2 is a call flow illustrating an example method for auctioning products for a specified time period;

FIG. 3 is a call flow illustrating another example method for auctioning products for a specified time period; and

FIG. 4 is a call flow illustrating an example method for qualifying a partner to auction rental periods.

Like reference symbols in the various drawings indicate like elements.

### DETAILED DESCRIPTION

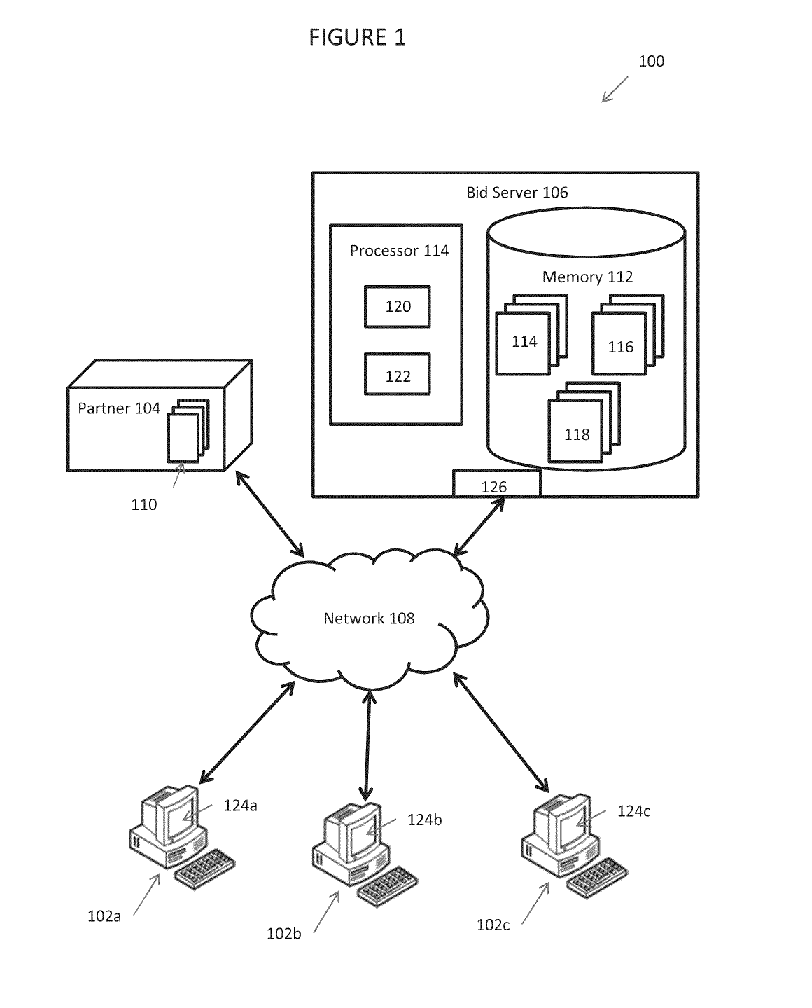

FIG. 1 illustrates an exemplary bidding system 100 for auctioning rental periods for products. For example, the system 100 may present products for rent for a specified period of time and auction the rental periods. Products may include physical goods such as jewelry, handbags, dresses, watches, sunglasses, cars, other physical products, digital products e.g. access to a research database and recurring services for rent e.g. a monthly haircut, carwash etc. Typically, a retailer or vendor prices goods for sale based on attributes (e.g., material, craftsmanship, cost of manufacturing, designer) and directly or indirectly sells the products to consumers. In the present disclosure, a retailer, vendor, or other enterprise can enter into an agreement with an enterprise configured to auction rental periods. In this case, the retailer, the vendor, or other enterprise is referred to as partner to the auctioning enterprise in the present disclosure. To facilitate rental of products, the system 100 may present products available for a rent period and evaluate bids for the rental period based on one or more criteria (e.g., bid amount, credit score). In some implementations, the system 100 may execute one or more of the following: receive product descriptions from a partner; generate product profiles based on the received descriptions; present the products in an auction identifying a rental period; evaluate one or more bids based on bids amounts and/or associate bidder profiles; notify a bidder of winning a rental period for a product; or others. By enabling bidding for a rental period, the system 100 may provide one or more of the following: enable partners to offer products online for a rental period for a limited fee; provide bidding consumers that do not win a bid a chance to rent the product with a percentage premium on top of the winning bid (e.g., 10%); define a winning bid at a defined minimum discount level or above; directly charge bidders the winning bid price; pay partners minus a certain percentage or set fee; if no bid was placed, not charging a partner unless enhanced features were selected (e.g., featured rental item, bigger pictures, display placement); applying, to bidders, rental terms and conditions for renting products; managing further charges, recurring charges and/or fraudulent actions of bidders (e.g., damage, loss); offering a partner to make a product a rental deal of the day (e.g., one day deal); enabling a partner to select a preferred date range for an offered product; filtering rental auctions and/or deals of the day based on a geographic location of the bidder; enabling a bidder to override a geographical filter to look for nearby or nationwide deals; notify users of rental deals and rental auction updates through, for example, email to registered bidders; customizing notifications based on bidder profiles (e.g., location, preferences); verifying address and phone number in bidder profiles match background checks prior to enabling bidders to participate in auctions; advertising a deal of the day per geographic region; and others.

As for a high level description of the elements, the system 100 includes clients 102a-c, a partner 104, and a bid server 106 coupled via network 108. The partner 104 includes product files 110 for identifying one or attributes of associated products. The bid server 106 includes memory 112 and processor 114. The memory 112 stores listing profiles 114 identifying product information and rental periods for products, bidder profiles 116 for identifying information associated with bidders, and auction files 118 for identifying information associated with product auctions. The processor 114 includes a listing engine 120 for generating listing profiles 114 based on product files 110 and auction engine 122 for auctioning rental periods based on listing profiles 114 and for generating auction files 118. The clients 102a-c may include Graphical User Interfaces (GUIs) 124a-c for presenting product auctions to users. As for a high-level description of operation, the partner 104 may transmit product descriptions 110 to listing engine 120 indicating a request to list the associated products in an auction. In response to at least the request, the listing engine 120 may generate listing profiles 114 including product descriptions and specified rental periods. The client 102 may transmit a request to the auction engine 122 for product auctions, and GUI 124 may present a display (e.g., Webpages) including information for one or more product auctions. In response to a user selection, the client 102 may transmit, to the auction engine 122, a bid for a rental period for a product, and the auction engine 118 may update an associated auction file 118 based on the receive bid. The auction engine 118 may determine a winning bid based on the associate auction file 118 and/or bidder profiles 116 and notify the winning bidder via, for example, email.

Turning to a more detailed description of the elements, the clients 102a-c are any devices (e.g., computing devices) operable to connect or communicate with the bid server 106 or network 108 using any communication link. Each client 102 includes, executes, or otherwise presents the GUI 124 and comprises an electronic device operable to receive, transmit, process and store any appropriate data associated with system 100. While the illustrated implementation includes clients 102a-c, the system 100 may include any number of clients 102 communicably coupled to the bid server 106. Further, “client 102” and “user” may be used interchangeably as appropriate without departing from the scope of this disclosure. Moreover, for ease of illustration, each client 102 is described in terms of being used by one user. But this disclosure contemplates that many users may use one device or that one user may use multiple devices.

As used in this disclosure, a user of client 102 is any person, department, organization, small business, enterprise, or any other entity that may use or request others to use system 100. Client 102 is intended to encompass a personal computer, touch screen terminal, workstation, network computer, kiosk, wireless data port, smart phone, personal data assistant (PDA), one or more processors within these or other devices, or any other suitable processing or electronic device used by a user viewing content from the bid server 106. For example, client 102 may be a PDA operable to wirelessly connect with an external or unsecured network. In another example, client 102 may comprise a laptop that includes an input device, such as a keypad, touch screen, mouse, or other device that can accept information, and an output device that conveys information associated with an auction of the bid server 106, including digital data, visual information, or GUI 124. Both the input device and output device may include fixed or removable storage media such as a magnetic computer disk, CD-ROM, or other suitable media to both receive input from and provide output to users of clients 102 through the display, namely the client portion of GUI 124.

GUI 124 comprises a graphical user interface operable to allow the user of client 102 to interface with at least a portion of system 100 for any suitable purpose, such as viewing auctions. Generally, GUI 124 provides the particular user with an efficient and user-friendly presentation of data provided by or communicated within system 100. GUI 124 may comprise a plurality of customizable frames or views having interactive fields, pull-down lists, and buttons operated by the user. For example, GUI 124 is operable to display certain auctions in a user-friendly form based on the user context and the displayed data. GUI 124 may also present a plurality of portals or dashboards. GUI 124 can be configurable, supporting a combination of tables and graphs (bar, line, pie, status dials, etc.), and build real-time dashboards. The term graphical user interface may be used in the singular or in the plural to describe one or more graphical user interfaces and each of the displays of a particular graphical user interface. Indeed, reference to GUI 124 may indicate a reference to the front-end or a component of the auction engine 122, as well as the particular interface accessible via client 102, as appropriate, without departing from the scope of this disclosure. Therefore, GUI 124 contemplates any graphical user interface (e.g., generic web browser, touch screen) that processes information in system 100 and efficiently presents the results to the user. Bid server 106 can accept data from client 102 via a the web browser (e.g., Microsoft Internet Explorer or Netscape Navigator) and return the appropriate HTML or XML responses to the browser using network 108, such as bids.

Partner 104 comprises an electronic device (e.g., computing device) operable to receive, transmit, process and store data associated with system 100. In the illustrated implementation, partner 104 provides information associated with products to bid server 106. In some implementations, the partner 104 may be owned or otherwise managed by a vendor, a retailer, a manufacturer, or other enterprise. In general, a vendor is generally an entity that manufacturers articles, products, or other commodities to sell and/or use. For example, a vendor may engage in the production, preparation, propagation, compounding, conversion, or processing of products. In some instances, a vendor transforms, by means of tools and/or processing steps (e.g., chemical reactions), raw materials into products for sale. In some instances, a vendor may provide or otherwise be associated with an entity that distributes the products such as retailers. A vendor may provide one or more of the following services associated with a product: inventory, warehousing, distribution, and/or transportation. A retailer is an entity that typically provides products directly to buyers. In some instances, a retailer buys or otherwise receives products from a vendor and then may sell these products directly to buyer. Similar to vendors, a retailer may provide one or more of the following services associated with a product: inventory, warehousing, distribution, and/or transportation. A retailer or vendor may include a single retail facility, one or more retail facilities at a single geographic location, and/or a plurality of retail facilities geographically distributed. In some cases, two or more of the illustrated entities may represent portions of the same legal entity or affiliates.

In the illustrated implementation, the partner 104 may include the product profiles 110 for identifying attributes of products that may be rented from the partner 104. For example, the product profiles 110 may identify or include one or more of the following: a product type; a name brand; product material; pricing information; weight; name; product identification; unit number; category (e.g., mechanical, electrical, automotive); sub-category; vendor or retailer information (e.g., address, phone number, store number); location information (e.g., county, city, state); vendor or retailer type (e.g., automotive, hardware); manufacturing date; number of items per unit; quality level (e.g., low, good, best); manufacturer; a brand name; a SKU; item description, size, measurements, product pictures, manufacturer logo; and/or any other parameters associated with an advertisement and/or media. In addition or alternatively, the product profile 110 may include information identifying a range of acceptable rental rates. For example, the product profile 110 may indicate that a partner 104 may never accept an offer less than 25% of a manufacturer's suggested retail price (MSRP).

Bid server 106 comprises an electronic computing device operable to receive, transmit, process and store data associated with system 100. System 100 can be implemented using computers other than servers, as well as a server pool. Indeed, bid server 106 may be any computer, electronic or processing device such as, for example, a blade server, general-purpose personal computer (PC), Macintosh, workstation, Unix-based computer, or any other suitable device. In other words, system 100 may include computers other than general purpose computers as well as computers without conventional operating systems. Bid server 106 may be adapted to execute any operating system including Linux, UNIX, Windows Server, or any other suitable operating system. In certain implementations, bid server 106 may also include or be communicably coupled with a web server and/or a mail server.

Bid server 106 includes memory 112 and a processor 114. Memory 112 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, memory 112 includes listing profiles 114, bidder profiles 116, and auction files 118, but may include other information without departing from the scope of this disclosure. Local memory 112 may also include any other appropriate data such as applications or services, firewall policies, a security or access log, print or other reporting files, HTML files or templates, data classes or object interfaces, child software applications or sub-systems, and others.

The listing profiles 114 include any parameters, pointers, variables, algorithms, instructions, rules, files, links, or other data for identifying products that may be rented from partner 104 using an auction. As discussed above, the listing profiles 114 may include or otherwise identify one or more of the following attributes associated with ad space: an auction period (e.g., start date, end date); beginning bid; a reserve; a rental period (e.g., date range); partner name; a bidder agreement; product information included in product profiles 110 (see description of profiles 110); maximum number of products available for rent, flag to indicate that bidders in line after the winning bid will get the items for x % extra on top of the winning bid; and/or other aspects associated with a rental auction or product. For example, the listing profile 114 may identify a manufacturer, a rental period, production information, and other parameters associated with renting a product.

The bidder profiles 116 include one or more data structures or entries for storing or otherwise identifying bidder information. For example, the bidder profile 116 may include a name. In general, a bidder profile 116 may include one or more of the following: a name; an address; a user identifier; a password; payment information (e.g., fees, payment history, subscription period); rental history; and/or any other information associated with a bidder. Each bidder profile 116 may be associated with a single bidder, and/or a plurality of bidder profiles 116 may be associated with a single bidder. The bidder profile 116 may be dynamically created or populated by bid server 106 (e.g., in response to a subscription), a third-party vendor, any suitable user of bid server 106, loaded from a default file, or received via network 108.

The auction files 118 include one or more entries or data structures that identify information associated with auctions presented through clients 102a-c and associated bids. For example, the auction files 118 may identify a product, auction period, received bids, and associated bidders. In some implementations, the auction files 118 may include or otherwise identify one or more of the following: a product description; auction history; auction period; bid amounts; bidder names; and others. In some implementations, the auction files 118 may be associated with a single auction, or a plurality of auction files 118 may be associated with multiple auctions. For example, the auction file 118 may be associated with multiple auctions for the partner 104.

Processor 114 executes instructions and manipulates data to perform operations of bid server 106. Although FIG. 1 illustrates a single processor 114 in server 106, multiple processors 118 may be used according to particular needs, and reference to processor 114 is meant to include multiple processors 118 where applicable. In the illustrated implementation, processor 114 executes listing engine 120 and auction engine 122 at any appropriate time such as, for example, in response to a request or input from a user of server 106 or any appropriate computer system coupled with network 108. The listing engine 120 includes any software, hardware, and/or firmware, or combination thereof, operable to generate listing profiles 114. For example, the listing engine 114 may receive product information included in product files 110 and generate associated listing profiles 114 identifying product information and an associated rental auction. In some implementations, the listing engine 114 may perform one or more calculations to determine one or more aspects of an auction. For example, the listing engine 114 may identify a retail price for the product and determine a starting rental bid based on a percentage of the retail price. For instance, if the retail price is $100.00, the starting rental price or minimum rental price may be $10. The listing engine 114 may determine a rental price based on the rental period. For example, the listing engine 114 may decrease an effective daily rental for longer rental periods. In these instances, the listing engine 114 may computer a one day rental as 10% of the retail price while a week rental may be 15% of the retail price, which has a lower rental cost per day. Regardless of calculations, the listing engine 114 may identify criteria for presenting an auction. For example, the listing engine 114 may determine the partner 104 is a preferred renter and include an indication in the listing profile 114 to list the auction above other auctions or provide other indications to bidders.

The auction engine 122 can include any software, hardware, firmware, or combination thereof configured to execute auctions for rental periods. For example, the auction engine 122 may determine the highest bid identified in the auction file 118 and assign the associated bidder winner of the auction. In some implementations, the auction engine 122 may determine a winning bidder based on other or additional criteria. For example, the auction engine 122 may determine a winning bid based on an bid amount and a rating (e.g., credit score) associated with a bidder. In these instances, the auction engine 122 may not assign the bidder with the highest bid amount as the winning bidder. In connection with identifying a winning bidder, the auction engine 122 may retrieve bidder information from an associated bidder profile 116 and transmit a request to the partner 104 to ship the product to the winning bidder. Prior to transmitting the request, the auction engine 122 may execute a transaction with a financial enterprise identified in the bidder profile 116. For example, the auction engine 122 may charge the bidder the winning bid and/or a deposit for the product.

Regardless of the particular implementation, “software,” as used herein, may include software, firmware, wired or programmed hardware, or any combination thereof as appropriate. Indeed, the listing engine 120 and the auction engine 122 may be written or described in any appropriate computer language including C, C++, Java, J#, Visual Basic, assembler, Perl, any suitable version of 4GL, as well as others. It will be understood that while the listing engine 120 and the auction engine 122are illustrated in FIG. 1 as including individual modules, each of the listing engine 120 and the auction engine 122 may include numerous other sub-modules or may instead be a single multi-tasked module that implements the various features and functionality through various objects, methods, or other processes. Further, while illustrated as internal to server 106, one or more processes associated with the listing engine 120 and/or the auction engine 122 may be stored, referenced, or executed remotely. Moreover, the listing engine 120 and/or the auction engine 122 may be a child or sub-module of another software module or enterprise application (not illustrated) without departing from the scope of this disclosure.

Bid server 106 may also include interface 126 for communicating with other computer systems, such as clients 102, over network 108 in a client-server or other distributed environment. In certain implementations, bid server 106 receives data from internal or external senders through interface 126 for storage in local memory 112 and/or processing by processor 114. Generally, interface 126 comprises logic encoded in software and/or hardware in a suitable combination and operable to communicate with network 108. More specifically, interface 126 may comprise software supporting one or more communications protocols associated with communications network 108 or hardware operable to communicate physical signals.

Network 108 facilitates wireless or wireline communication between server 106 and any other local or remote computer, such as clients 102. Network 108 may be all or a portion of an enterprise or secured network. While illustrated as single network, network 108 may be a continuous network logically divided into various sub-nets or virtual networks without departing from the scope of this disclosure, so long as at least portion of network 108 may facilitate auction displays and bids between server 106 and at least one client 102. In some implementations, network 108 encompasses any internal or external network, networks, sub-network, or combination thereof operable to facilitate communications between various computing components in system 100. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

In one aspect of operation, the partner 104 transmits product information to the listing engine based on the product files 110. Prior to transmitting the request or in connection with the request, the bid server 106 may request additional information from the partner 104 to qualify the associated enterprise. For example, the bid server 106 may evaluate a credit rating, a better business bureau score, and/or other criteria prior to granting access to the bid server 106. Regardless, the listing engine 120 receives the product information and generates a listing profile 114 based on the product information. The list file 114 may include information defining an auction for a rental period such as the product description, the auction start and end dates, a starting bid, a rental period, and/or other information. The auction engine 122 auctions a rental period for the product in accordance with the listing profile 114. For example, the auction engine 122 may generate a display including a product description, starting bid, rental period, and other information. In response to bids, the auction engine 122 may update an associated auction file 118 based on information included in the bids such as a bid amount. In connection with the auction expiring, the auction engine 122 may determine a winning bidder based on the auction file 118. For example, the auction engine 122 may assign a bidder with the highest offer for the rental period. In some instances, the auction engine 122 may assign a winning bidder based on other criteria such as credit ratings of the bidders. The auction engine 122 may execute a financial transaction in accordance with information included in a bidder profile 116 and, once executed, transmit a request to the partner 104 to ship the product to the winning bidder.

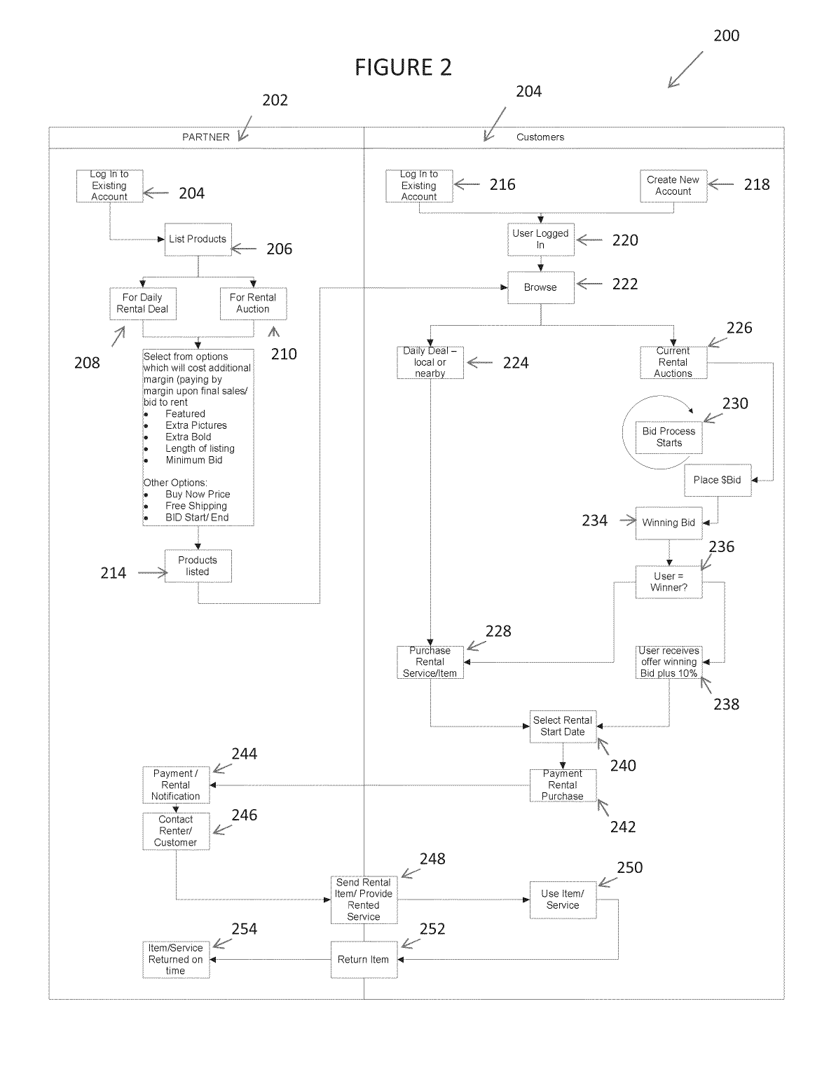

FIG. 2 is a call flow 200 for executing an auction for a rental period in accordance with some implementations of the present disclosure. In particular, the call flow 200 illustrates actions execute by partner 202 and customer 204. The partner 202 may initially login into an existing account at step 204. For example, a user of the partner 104 in FIG. 1 may login into an existing account managed by bid server 106. At step 206, the partner 202 may upload a list of products to auction for rental periods. In the example, the partner 104 may identify a list of products based on the product files 110 and transmit the list including product information to the bid server. The partner 202 may select a product for a daily rental deal 208 at step or for a rental auction at step 210. Again returning to the example, the user may select an auction type for each of the identified products using the bid server 106. Next, at step 212, the partner 202 may execute additional selections, which may cost additional fees. For example, the selections may include: presenting the product as a featured item; presenting additional pictures; presenting at least some text in bold; increasing a length of a standard listing; setting a minimum bid; enabling a buy now option to bidders; enabling free shipping for the winning bidder; setting a start and an end; or others. The partner 204 lists the products for auctioning rental periods at step 214. As for the example, in connection with selecting one or more features for the listed products, the partner 104 may transmit a request to the bid server 106 to list the products in an auction for rental periods.

As for the bidder's actions, the customer 204 may request to log into an existing account at step 216 or create a new account at step 218. In terms of creating a new account, the customer 204 may need to initially be approved prior to bidding on products such as evaluating a crediting rating for the customer. Again in the example, a user of client 102 may access the bid server 106 through network 108 and request to login into an existing account with access to the bidder profile 116 or create a new account which may include generating a bidder profile 116. Regardless, the customer 204 may login into the account using, for example, a username and password at step 220 and browse products being auctioned for a rental period at step 224. As for the example, the client 102 may transmit a request for a list of auction rentals to the bid server and present received information through the GUI 124.

In the process of browsing, the customer 204 may select daily deals (e.g., local, nearby) at step 224 or select current rental auctions at step 226. In the example, the GUI 124 may present a selection for one or more daily deals or for current rental auctions. In regards to the daily deal, the customer 224 may purchase the product rental at step 228. As for the example, the user may, when viewing a daily deal, may select a graphical element associated with immediately purchasing the rental period without participating in an auction. As for the rental auctions, the customer 204 may indicate a request to participate in a specific rental auction at step 230 and submit a bid at step 232. Returning to the example, the user of client 102 may select a rental auction through the GUI 124 and enter a bid for the product rental through the GUI 124. In these instances, the client 102 may transmit the bid amount to the bid server 106. In some instances, bidders may submit multiple bids during the course of an auction. A winning bidder is determined at step 234. As for the example, the auction engine 122 may determine a winning bidder based on the auction files 118 and/or the bidder profile 116. For example, the winning bidder may be the highest bidder or a bidder including the highest rating. If the customer 204 is the winning bidder at decisional step 236, the customer purchases the rental period at step 228. In the example, the auction engine 122 may execute a financial transaction using information provided by the bidder via the GUI and/or stored in the bidder profile 116. If the customer 204 is not the winning bidder, the customer may be offered the rental period at the winning bid plus an additional fee (e.g., 10% of the winning bid) at step 238. The customer 204 may select a start date for the rental period at step 240. Again returning to the example, the user of client 102 may select or otherwise indicate a starting date through GUI 124, and the client 102 may transmit the selection to the auction engine 124. At step 242, the winning bidder pays for the rental period. As for the example, the user may enter financial information through the GUI 124 to execute the purchase and/or the auction engine 124 may retrieve financial information from the bidder profile 116.

After executing the financial transaction, the partner 202 may be notified, at step 244, of the auction results including, for example, identifying the winning bidder and winning bid. In the example, the auction engine 124 may retrieve bidder information (e.g., contact information) from the bidder profile 116 and transmit the auction results to the partner 104. At step 246, the partner 202 may contact the winning bidder to request, for example, a mailing address or other information. Next, at step 248, the partner 204 mails the product to the winning bidder for use during the rental period. The customer 204 uses the product during the rental period at step 250 and returns the product 252 to the partner at step 252. The partner 204 verifies that the product was returning within the rental period at step 254.

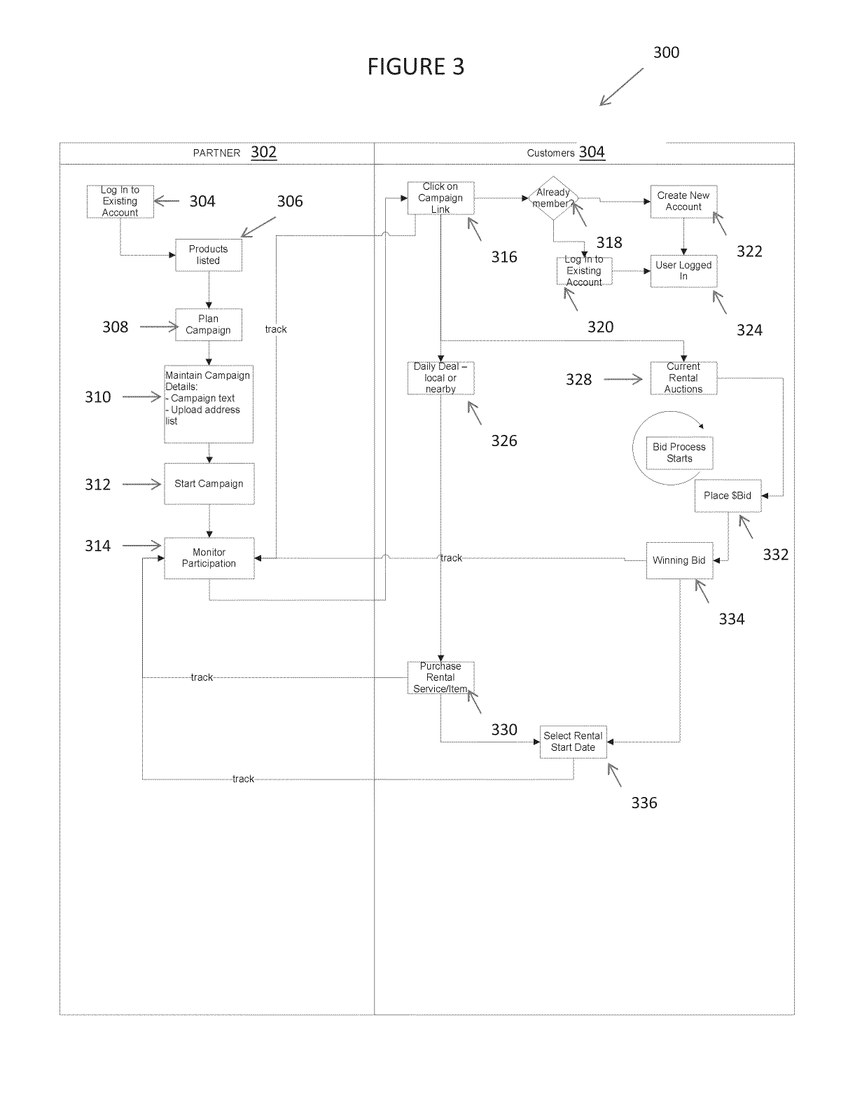

FIG. 3 is a call flow 300 for executing an auction for a rental period in accordance with some implementations of the present disclosure. In particular, the call flow 300 illustrates actions execute by partner 302 and customer 304. The partner 302 may initially login into an existing account at step 304. For example, a user of the partner 104 in FIG. 1 may login into an existing account managed by bid server 106. At step 306, the partner 302 may upload a list of products to auction for rental periods. In the example, the partner 104 may identify a list of products based on the product files 110 and transmit the list including product information to the bid server. The partner 302 may select a plan campaign such as a mass email (or SMS or social media) blast with a link back to the campaign offer at step 308. Next, at step 310, the partner 302 may provide campaign details such as campaign text to be shown in the email form to be used in the campaign and upload list. Functionality may include either uploading in house owned email address lists or rented email lists. The partner 204 starts the campaign at step 312 and monitors participation at step 314.

As for the bidder's actions, the customer 204 may click on campaign link at step 316. If the user is already a member at decisional step 318, then, at step 320, the customer may log into an existing account. If not, the customer 304 may create a new account at step 322. In terms of creating a new account, the customer 304 may need to initially be approved prior to bidding on products such as evaluating a crediting rating for the customer. Again in the example, a user of client 102 may access the bid server 106 through network 108 and request to login into an existing account with access to the bidder profile 116 or create a new account which may include generating a bidder profile 116. Regardless, the customer 204 may be logged in the account using, for example, a username and password at step 324.

In the process of browsing, the customer 304 may select daily deals (e.g., local, nearby) at step 326 or select current rental auctions at step 328. In the example, the GUI 124 may present a selection for one or more daily deals or for current rental auctions. In regards to the daily deal, the customer 304 may purchase the product rental at step 330. As for the example, the user may, when viewing a daily deal, may select a graphical element associated with immediately purchasing the rental period without participating in an auction. As for the rental auctions, the customer 304 may submit a bid at step 332. Returning to the example, the user of client 102 may enter a bid for the product rental through the GUI 124. In these instances, the client 102 may transmit the bid amount to the bid server 106. A winning bidder is determined at step 334. As for the example, the auction engine 122 may determine a winning bidder based on the auction files 118 and/or the bidder profile 116. For example, the winning bidder may be the highest bidder or a bidder including the highest rating. The customer 304 may select a start date for the rental period at step 336. Again returning to the example, the user of client 102 may select or otherwise indicate a starting date through GUI 124, and the client 102 may transmit the selection to the auction engine 124.

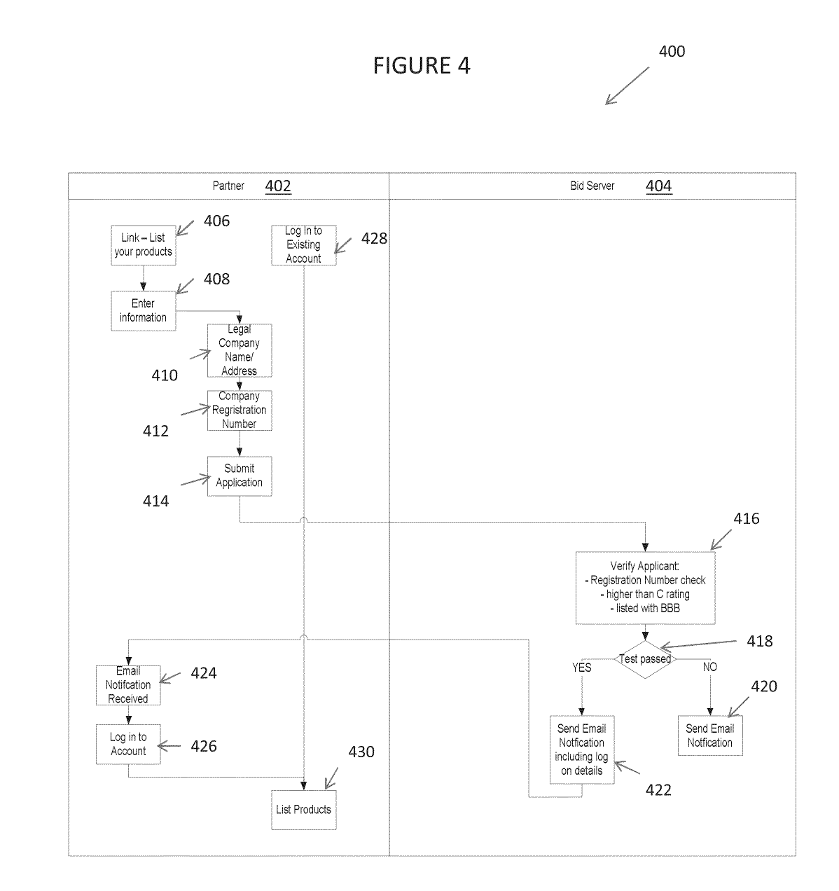

FIG. 4 is a call flow 400 for qualifying a potential partner for auctioning rental periods. If the partner 402 has not previously registered with the bid server 304, the partner 402 may indicate to the bid server 406 a request to list products in rental auctions at step 406. For example, the partner 104 in FIG. 1 may transmit, to the bid server 106, a request to access auction services. The partner 402 may enter information at step 408 such as legal name and address at step 410 and company registration number at step 412. In the example, the partner 104 may receive, from the bid server 106, a request for information such as an application. The partner 302 submits the application at step 414. As for the example, the partner 104 may transmit the application through network 108. The bid server 204 verifies the potential partner at step 416 by determining accuracy of the registration number, a higher than C credit rating, and membership with the Better Business Bureau. Returning to the example, the bid server 106 may receive information associated with the partner 104 through the network 108 and determine whether the information satisfies one or more criteria. If the potential partner does not qualify at decisional step 418, then, at step 420, an email notification is sent to the partner. If the potential partner does qualify, then, at step 422, an email notification including log on details is transmitted to the partner 402. The partner 402 may receive the notification at step 424 and login into the account at step 426. In addition, the partner 402 may login into the existing account at a future time at step 428. Regardless, the partner 302 may list products for the auction rental at step 430.

A number of embodiments of the invention have been described. Nevertheless, it will be understood that various modifications may be made without departing from the spirit and scope of the invention. Accordingly, other embodiments are within the scope of the following claims.

What is claimed is:

1. A method for auctioning, comprising:
presenting selection between a deal for a rental period for a product, digital product or service that enables a user to purchase a rental period for a specified amount and an auction a rental period for a product over an auction period, wherein the product is possessed by a partner and a bid server manages the deal and the auction;
if the deal is selected, transmitting a request to the partner to send the user the product;
if the auction is selected, determining whether the user submitted a winning bidder based on bids received during the auction period; and
transmitting a request to the partner to ship the product to the user if the user selected the deal or is the winning bidder.

2. The method of claim 1, wherein the user selected the deal, and the rental period comprising an initial rental period, further comprising presenting an offer for another rental period larger than the initial rental period for an amount greater than the specified amount.

3. The method of claim 1, further comprising:
receiving a description of the product from the partner;
determining a starting bid for the rental period based on the product information; and
presenting the auction for the rental period to a plurality of bidders.

4. The method of claim 3, wherein determining the starting bid comprises receiving an initial bid, including a discount, from the partner or a third-party service.

5. The method of claim 1, further comprising:
determining a credit rating for the partner; and
determining whether to grant access to the bid server based on credit rating.

6. The method of claim 5, further comprising:
determining to grant access to the bid server; and
notifying the partner of access to the bid server.

7. The method of claim 1, wherein the user selects the auction and submits a bid, the method further comprising:
determining a bid for each of a plurality of bidders;
determining a credit rating for each of the plurality of bidders; and
determining a winning bid based on the bid and the credit rating for each of the plurality of bidders.

8. The method of claim 1, wherein the request includes an address for the winning bidder.

9. The method of claim 1, further comprising executing a financial transaction with the winning bidder prior to transmitting the request to the partner.

10. The method of claim 1, wherein the product comprises a first product and the rental period comprises a first rental period, the method further comprising:
receiving a list of products including the first product and a second product;
receiving a request to offer the second product at a set price for the rental periods; and
offering the rental period for the second product at a set price.

11. The method of claim 1, further comprising:
receiving, from the partner, a list of customer emails from the partner; and
emailing customers notification of the auction for the rental period.

12. The method of claim 1, further comprising transferring funds to the partner in response to at least one of the deal or the auction.

13. A computer program product encoded on a tangible, non-transitory storage medium, the product comprising computer readable instructions for causing one or more processors to perform operations comprising:
presenting selection between a deal for a rental period for a product that enables a user to purchase a rental period for a specified amount and an auction a rental period for a product over an auction period, wherein the product is possessed by a partner and a bid server manages the deal and the auction;
if the deal is selected, transmitting a request to the partner to send the user the product;
if the auction is selected, determining whether the user submitted a winning bidder based on bids received during the auction period; and
transmitting a request to the partner to ship the product to the user if the user selected the deal or is the winning bidder.

14. The computer program product of claim 13, the instructions further comprising:
receiving a description of the product from the partner;
determining a starting bid for the rental period based on the product information; and
presenting the auction for the rental period to a plurality of bidders.

15. The computer program product of claim 13, the instructions further comprising:
determining a credit rating for the partner; and
determining whether to grant access to the bid server based on credit rating.

16. The computer program product of claim 15, the instructions further comprising:
determining to grant access to the bid server; and
notifying the partner of access to the bid server.

17. The computer program product of claim 13, wherein the user selects the auction and submits a bid, the instructions further comprising:
determining a bid for each of a plurality of bidders;
determining a credit rating for each of the plurality of bidders; and
determining a winning bid based on the bid and the credit rating for each of the plurality of bidders.

18. The computer program product of claim 13, wherein the product comprises a first product and the rental period comprises a first rental period, the instructions further comprising:
receiving a list of products including the first product and a second product;
receiving a request to offer the second product at a set price for the rental periods; and
offering the rental period for the second product at a set price.

19. The computer program product of claim 13, the instructions further comprising:
receiving, from the partner, a list of customer emails from the partner; and
emailing customers notification of the auction for the rental period.

20. The computer program product of claim 13, the instructions further comprising transferring funds to the partner in response to at least one of the deal or the auction.
